(19) United States
(12) Patent Application Publication
(10) Pub. No.: US 2011/0005614 A1
(43) Pub. Date: Jan. 13, 2011

(54) VENT VALVE

(75) Inventors: Daniel Lee Pifer, Chelsea, MI (US); Charles Joseph Martin, Dexter, MI (US); Robert P. Benjey, Dexter, MI (US); Andrew McIntosh, Chicago, IL (US)

Correspondence Address: DYKEMA GOSSETT PLLC, 39577 WOODWARD AVENUE, SUITE 300, BLOOMFIELD HILLS, MI, 48304-5086, US

(73) Assignee: Eaton Corporation, Cleveland, OH (US)

(21) Appl. No.: 12/498,451

(22) Filed: Jul. 7, 2009

(51) Int. Cl. F16K 15/00; F16K 31/18

(52) U.S. Cl. 137/409; 137/511

(57) ABSTRACT

A vent valve assembly at least partially disposed within an interior of a fuel tank is provided. The vent valve assembly comprises a housing, a first venting orifice, a float configured to close the first venting orifice when the level of fuel in the housing reaches a predetermined level, a second venting orifice, and a stop configured to close the second venting orifice to facilitate a pressure differential between the housing and the fuel tank.

### BACKGROUND

a. Field of Invention

The invention relates generally to a vent valve assembly, including a fill limit vent valve assembly that is capable of preventing overfilling of a fuel tank and reducing fuel carry-over during dynamic conditions.

b. Description of Related Art

Fuel level responsive vent valves are conventionally used in vehicle fuel tanks. Vent valves may employ a float which may close a venting orifice under certain conditions. The venting orifice of the vent valve may remain open when the fuel is below a certain level and may close when the fuel reaches the valve. Vent valves may thereby control fuel tank ventilation to prevent overpressure and vacuum conditions in the fuel tank. Vent valves (i.e., fuel shutoff or “fill limit” vent valves) may also thereby prevent vapor flow when the fuel level in the fuel tank reaches a predetermined level in order to create a pressure head within the fuel tank and filler pipe to operate automatic shutoff and may also prevent liquid fuel from sloshing out of the venting orifice.

Conventional vent valves may perform at various degrees of effectiveness under static conditions and dynamic conditions (e.g., during refueling). There is a desire for a vent valve that is capable of allowing a faster drain of liquid fuel from the vicinity of the venting orifice in order to prevent residual liquid from being carried into the air stream and out of the vent valve (i.e., reducing liquid carry-over during dynamic conditions).

### SUMMARY

A vent valve assembly comprising a housing, a first venting orifice, a float, and a second venting orifice is provided. In an embodiment, the vent valve assembly includes a ball-stop configured to close the second venting orifice to facilitate a pressure differential between the housing and the fuel tank.

Various features of this invention will become apparent to those skilled in the art from the following detailed description, which illustrates embodiments and features of this invention by way of non-limiting examples.

### BRIEF DESCRIPTION OF THE DRAWINGS

Embodiments of the invention will now be described, by way of example, with reference to the accompanying drawings, wherein:

FIG. 1 is a schematic view of a vehicle fuel system employing a valve in accordance with an embodiment of the invention.

FIG. 2 is a cross-sectional view of a valve in accordance with an embodiment of the invention.

FIG. 3 is a cross-sectional view of a portion of the valve of FIG. 2, a cone, in accordance with an embodiment of the invention.

### DETAILED DESCRIPTION

Reference will now be made in detail to embodiments of the present invention, examples of which are illustrated in the accompanying drawings. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as embodied in or defined by the appended claims.

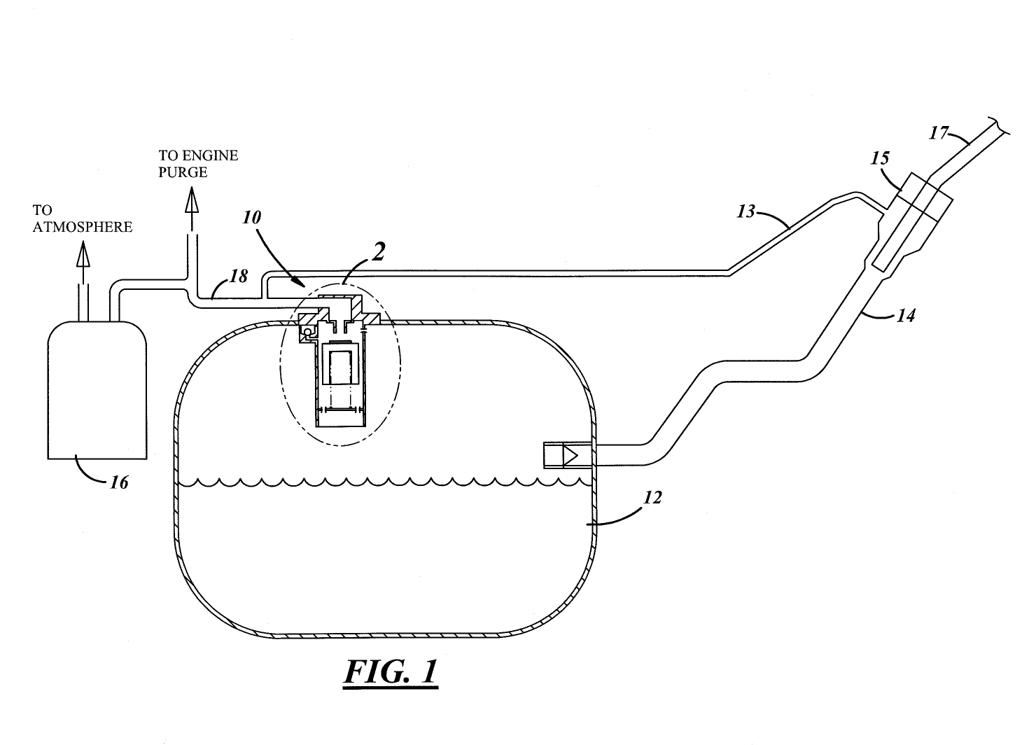

Referring now to FIG. 1 which illustrates a schematic view of a vehicle fuel system, a fill limit vent valve 10 may be generally mounted in the fuel tank 12 of a vehicle fuel system. The vehicle fuel system may include a recirculation line 13, a fill cup 15, and a refueling nozzle 17. The vehicle fuel system may also include a fill pipe 14 for introducing fuel into the fuel tank 12 and a vapor recovery system (e.g., vapor canister) 16 to which fuel vapor is vented from the tank 12 through valve 10 and vent line 18. When the fuel level in the tank 12 is below valve 10, valve 10 may be open and may provide high volume venting of fuel vapor to vapor recovery system 16. When liquid fuel reaches valve 10, valve 10 may respond by closing, thereby shutting off flow to the vapor recovery system 16.

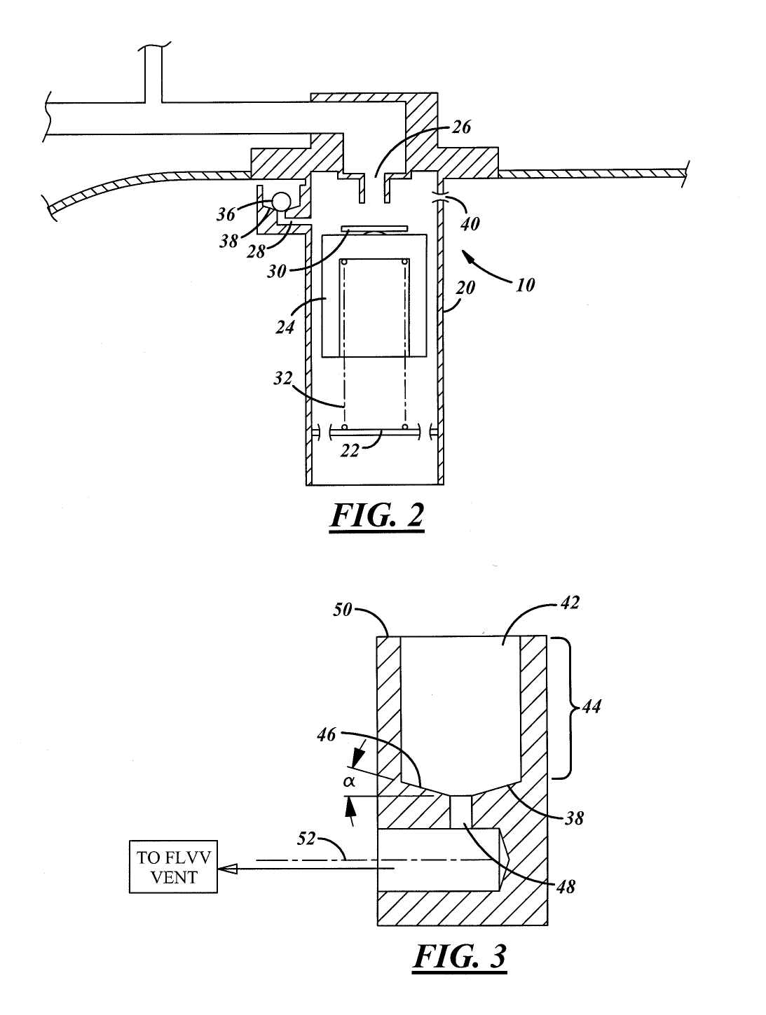

Referring now to FIG. 2, housing 20 may be provided to house an internal valve mechanism for valve 10. Housing 20 may be cylindrical or generally cylindrical in shape. Housing 20 may be molded, for example, from a fuel-resistant plastic, and if desired, may be mounted in a wall of fuel tank 12. Housing 20 may define a plane (e.g., collar) 22 for allowing vapor to flow into housing 20 around a float 24 and out first venting orifice 26, as described further below. When the fuel level reaches a predetermined level at the bottom of housing 20, vapor flow may be stopped from flowing from the bottom of housing 20. At the predetermined fuel level, vapor may only flow through a second venting orifice 28.

First venting orifice 26 may be provided for venting of vapor within valve 10 to vent recovery system 16. As described below, first venting orifice 26 may be temporarily closed under certain fuel conditions. When first venting orifice 26 is closed, pressure inside housing 20 may increase, causing pressure in the fuel tank 12 to also increase and eventually shut-off fuel filling from a fuel pump (not shown).

The internal valve mechanism of valve 10 may comprise a float 24, seal 30, and resilient member 32. Float 24 may be provided for closing first venting orifice 26 when the level of fuel in housing 20 reaches a select or predetermined level. Float 24 may be movable within housing 20 in order to move up and down in response to the level of fuel in fuel tank 12. In an embodiment, when the fuel level is at about ¾ of the height of float 24, float 24 may float. Float 24 may be configured and sized so as to move freely up and down in a controlled manner within housing 20.

Seal 30 may be provided for closing first venting orifice 26 when the level of fuel in housing 20 reaches a select or predetermined level. Seal 30 may be connected to float 24.

Resilient member 32 may be provided for supplying a force (e.g., spring force) to move float 24 when the level of fuel in housing 20 reaches a select or predetermined level, so that float 24 may have a range of spring-based motion. In an embodiment, resilient member 32 may comprise a spring. The float 24 and resilient member 32 are biased to closed (i.e., first venting orifice 26 is closed by float 24) in the presence of a liquid buoyant force. Without the presence of a liquid (e.g., fuel), float 24 is designed to be heavier than the force of resilient member 32 so that float 24 may move to an open position (i.e., first venting orifice 26 is open and is not closed by float 24).

Second venting orifice 28 may be provided for venting of vapor when the fuel level in housing 20 reaches a select or predetermined level, such that first venting orifice 26 may be closed. Accordingly, fuel vapor may continue to vent from housing 20 through second venting orifice 28. Once the pressure differential between the housing 20 and the fuel tank 12 is substantially equalized, the weight of float 24 may cause float 24 to move down and open first venting orifice 26. An operator may then be able to “trickle fill” an additional amount of fuel under these circumstances. Second venting orifice 28 may be located near the top of housing 20. Second venting orifice 28 may be in series with first venting orifice 26. Second venting orifice 26 may be smaller in diameter than first venting orifice 26. For example, in an embodiment, second venting orifice 28 may be between approximately 1.5 and 3 mm in diameter. Because second venting orifice 28 may be smaller than first venting orifice 26 or because second venting orifice 26 may be closed, a pressure differential may develop between fuel tank 12 and the interior of housing 20 during refueling. This pressure differential may cause liquid fuel to enter the bottom of housing 20, thereby causing float 24 to rise and close first venting orifice 26, which opens to the vent recovery system 16. The stopping of vapor flow through first venting orifice 26 can cause the pressure of fuel tank 12 to rise, causing the fuel level to rise in fill pipe 14. When the refueling nozzle 17 is reached, refueling may be shut-off. This method for fuel shut-off may be generally referred to as “dip tube shut off.” In order to prevent operator “trickle-fill,” in which operators attempt to add additional fuel into fuel tank 12 after initial shut-off, the size of second venting orifice 28 may be relatively small in comparison to the size of first venting orifice 26. Second venting orifice 28 may even be closed in an embodiment under certain conditions. For example, in an embodiment, second venting orifice 28 may be closed when a vehicle is in a stopped position. The period of time between each “trickle-fill” may be determined by the size of second venting orifice 28. Accordingly, modification to the size of second venting orifice 28 may either decrease or increase the period of time between shut-off clicks during trickle-fill. For some applications, it may be desirable to provide a smaller second venting orifice 28 since the longer it takes to permit pressure equalization between housing 20 and fuel tank 12, the less “trickle-fill” may be allowed during refueling. If second venting orifice 28 is closed, some pressure may be retained in fuel tank 12 which may help limit “trickle-fill.”

Second venting orifice 28 may be provided to reduce carryover during dynamic conditions (e.g., refueling) by preventing residual liquid (e.g., fuel) from being carried into the vapor stream and carried out of the vent valve 10. In order to better allow gravity to remove liquid (e.g., fuel) from the inside of housing 20, the vapor must be allowed to replace the escaping liquid. Accordingly, second venting orifice 28 may allow vapor to replace the escaping liquid providing a quicker drain of liquid. To provide for a quicker drain of fluid from housing 20, the size of second venting orifice 28 may be of an increased size than is desirable for controlling “trickle-fill.” In other words, the desired size of second venting orifice 28 for improving drainage of fluid from housing 20 (in order to prevent residual liquid from being carried into the vapor stream) may be counterbalanced by the desired size of second venting orifice 28 for controlling “trickle-fill.”

Stop 36 may be configured to close second venting orifice 28 to facilitate a pressure differential between the housing 20 and the fuel tank 12. Stop 36 may therefore modify the size of second venting orifice 28 and optimize the size of second venting orifice 28 depending upon whether second venting orifice 28 is being used to control “trickle-fill” or is being used to improve drainage of fuel from housing 20 in order to prevent residual liquid from being carried into the vapor stream. For example, second venting orifice 28 may be larger during dynamic conditions (e.g., refueling) because the means 34 for closing the second venting orifice 28 may not be engaged. The larger size of second venting orifice 28 may allow liquid (e.g., fuel) to drain faster under dynamic conditions by allowing a greater amount of vapor to enter housing 20 and more quickly remove liquid from inside housing 20. During static (i.e., non-dynamic) conditions, means 34 for closing second venting orifice 28 may be engaged in order to close second venting orifice 28. The closing of second venting orifice 28 may facilitate a pressure differential between fuel tank 12 and the interior of housing 20 in order to assist with controlling “trickle-fill.”

Stop 36 may be disposed above second venting orifice 28. Stop 36 may comprise steel. In an embodiment, stop 36 may comprise a ball-stop. Stop 36 may be generally spherical in shape. If stop 36 is spherical, it may move easily when a vehicle is in motion. Stop 36 may be configured in size and shape so as to close second venting orifice 28. In an embodiment, stop 36 may be approximately between about 8.7 mm and about 12.7 mm (i.e., about 11/32 and about ½ inches) in diameter.

Cone 38 may be provided for housing stop 36. Cone 38 may define second venting orifice 28. Cone 38 may be configured in size and shape so as to retain stop 36. In an embodiment, cone 38 may be configured in size and shape so as to cause stop 36 to return to the center of cone 38 when the vehicle in which valve 10 is used is not moving. Cone 38 may comprise nylon or an acetal resin engineering plastic such as that sold by DuPont under the brand name DELRIN®. Referring now to FIG. 3, a cross-sectional view of a cone 38 is illustrated. In the illustrated embodiment, cone 38 may be approximately 0.875 mm in cross-sectional width and may define a top orifice 42 of approximately 0.625 mm in diameter. Cone 38 may be approximately 1.50 mm in height and may define an interior height 44 of approximately 0.75 mm. The interior bottom 46 of cone 38 may taper radially inwardly at an approximately 5° angle α toward an internal orifice 48 of approximately 0.100 mm in width. In an embodiment, angle α may range between approximately 3° and 10°. The distance from the top 50 of cone 38 to a midpoint 52 of second venting orifice 28 may be approximately 1.125 mm. Although these measurements are described in detail, it is understood by those of ordinary skill in the art that numerous other measurements may be used in connection with cone 38 and remain within the spirit and scope of the invention.

If desired, a third venting orifice 40 may be included in housing 20 for permitting venting of fuel tank 12 at certain pressures in valve 10. Third venting orifice 40 may be in parallel with second venting orifice 28, and may include a head valve (not shown) for opening third venting orifice 40 at selected pressures in valve 10. For example, third venting orifice 40 may be opened to vent fuel tank 12 at tank pressures above fill conditions.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. It is intended that the scope of the invention be defined by the claims and their equivalents.

What is claimed is:

1. A vent valve assembly at least partially disposed within an interior of a fuel tank, the vent valve assembly comprising:
a housing, the housing defining a chamber;
a first venting orifice located in the housing for venting of vapor from the housing;
a float disposed within the chamber configured to close the first venting orifice when the level of fuel in the housing reaches a predetermined level;
a second venting orifice in fluid communication with the chamber, the second venting orifice for venting of the vapor from the housing or for allowing vapor to enter the housing; and
a stop configured to close the second venting orifice to facilitate a pressure differential between the housing and the fuel tank.

2. A vent valve assembly in accordance with claim 1, wherein the housing includes a plane for allowing vapor to flow into the housing around the float and out the first venting orifice.

3. A vent valve assembly in accordance with claim 1, wherein the float closes the first venting orifice in response to a predetermined level of fuel through an increased buoyancy force.

4. A vent valve assembly in accordance with claim 1, wherein the first venting orifice is connected to a vapor recovery system.

5. A vent valve assembly in accordance with claim 1, further comprising a seal connected to the float for closing the first venting orifice when the level of fuel in the housing reaches a predetermined level.

6. A vent valve assembly in accordance with claim 1, wherein the second venting orifice is located at or near the top of the housing.

7. A vent valve assembly in accordance with claim 1, wherein the second venting orifice is in series with the first venting orifice.

8. A vent valve assembly in accordance with claim 1, wherein the second venting orifice is smaller in diameter than the first venting orifice.

9. A vent valve assembly in accordance with claim 1, wherein the second venting orifice is between approximately 1.5 and 3 mm in diameter.

10. A vent valve assembly in accordance with claim 1, wherein the stop is disposed above the second venting orifice.

11. A vent valve assembly in accordance with claim 1, wherein the stop comprises steel.

12. A vent valve assembly in accordance with claim 1, wherein the stop is spherical.

13. A vent valve assembly in accordance with claim 1, further comprising a cone for housing the stop.

14. A vent valve assembly in accordance with claim 13, wherein the cone comprises nylon or an acetal resin engineering plastic.

15. A vent valve assembly in accordance with claim 10 wherein the interior bottom of the cone tapers radially inwardly at an angle between approximately 3° to 10°.

16. A vent valve assembly in accordance with claim 1, further comprising a resilient member for providing a spring force to move the float.

17. A vent valve assembly in accordance with claim 1, further comprising a third venting orifice disposed in the housing.

18. A vent valve assembly in accordance with claim 17, wherein the third venting orifice is in parallel with the second venting orifice.

19. A vent valve assembly in accordance with claim 18, wherein the third venting orifice includes a head valve for opening the third venting orifice at selected pressures in the vent valve assembly.

20. A vent valve assembly at least partially disposed within an interior of a fuel tank, the vent valve assembly comprising:
a housing, the housing defining a chamber;
a first venting orifice located in the housing for venting of vapor from the housing;
a means for closing the first venting orifice when the level of fuel in the housing reaches a predetermined level;
a means for providing a spring force to activate the means for closing the first venting orifice when the level of fuel in the housing reaches a predetermined level;
a second venting orifice in fluid communication with the chamber, the second venting orifice for venting of the vapor from the housing or for allowing vapor to enter the housing; and
a means for closing the second venting orifice to facilitate a pressure differential between the housing and the fuel tank.

21. A vent valve assembly in accordance with claim 20, wherein the means for closing the second venting orifice comprises a ball disposed in a cone.

22. A vent valve assembly at least partially disposed within an interior of a fuel tank, the vent valve assembly comprising:
a housing, the housing defining a chamber;
a first venting orifice located in the housing for venting of vapor from the housing to a vapor recovery system;
a float disposed within the chamber, the float including a seal configured to close the first venting orifice through an increased buoyancy force when the level of fuel in the housing reaches a predetermined level;
a second venting orifice located at or near the top of the housing, wherein the second venting orifice is in fluid communication with the chamber, is in series with the first venting orifice, and is smaller in diameter than the first venting orifice;
a ball-stop disposed above the second venting orifice and configured to close the second venting orifice to facilitate a pressure differential between the housing and the fuel tank; and
a third venting orifice disposed in the housing, the third venting orifice in parallel with the second venting orifice and including a head valve for opening the third venting orifice at selected pressures in the vent valve assembly,
wherein the housing includes a plane for allowing vapor to flow into the housing, around the float, and out the first venting orifice.
